(19) United States
(12) Patent Application Publication
(10) Pub. No.: US 2009/0020969 A1
(43) Pub. Date: Jan. 22, 2009

(54) WHEELED MOVING BODY AND GROUNDING CONDITION MONITORING APPARATUS FOR THE SAME

(76) Inventors: Toru Nakagawa, Tokyo (JP); Toshikazu Numaguchi, Tokyo (JP); Hideya Maki, Tokyo (JP)

Correspondence Address: 3M INNOVATIVE PROPERTIES COMPANY, PO BOX 33427, ST. PAUL, MN, 55133-3427, US

(21) Appl. No.: 12/281,255

(22) PCT Filed: Mar. 12, 2007
(86) PCT No.: PCT/US2007/063821

§ 371 Date: Aug. 29, 2008

(30) Foreign Application Priority Data
Mar. 14, 2006 (JP) 2006-068589

(51) Int. Cl. B60D 99/00; H05F 3/02

(52) U.S. Cl. 280/29; 361/212

(57) ABSTRACT

To provide a wheeled moving body incorporating electrostatic protection measures and capable of constantly monitoring its grounding condition, and a grounding condition monitoring system for the same. An electrostatic conductive mat 14 on a cart 10 is connected to an electrostatic conductive wheel 12 for grounding, and one end of an ohm meter (or volt meter) 18 mounted on the cart 10 is connected to the electrostatic conductive mat 14, while the other end is grounded by connecting it to a conductive wheel 24 insulated from the cart 10 by an insulating plate 13.

### TECHNICAL FIELD

The present invention relates to a wheeled moving body, such as a pushcart, a shelf with casters, and a workbench with casters, and a moving body having track-like rolling means, with provisions made for protection against electrostatic discharge, and also relates to a grounding condition monitoring apparatus for the same.

### BACKGROUND ART

When transporting electrostatic-sensitive electronic parts, semifinished products, etc. in a factory, some measures must be taken to protect them against electrostatic discharge, because the static electricity generated by the wheels of a transport cart rolling over the floor can destroy the electronic parts and semiconductors.

In the prior art, electrostatic protection measures are taken, as shown in FIG. 1, by making a wheel 12 of a transport cart 10 conductive and connecting an electrostatic conductive mat 14, placed on the cart 10, to the bearing of the wheel 12 for grounding to the floor 16. For example, in Patent Document 1 given below, it is proposed that a rubber or resin material prepared by mixing therein an electrically conductive metal such as silver or nickel be used as the material for the rollers of the casters of the cart. In a simpler method, a metal chain or belt-like conductive sheet is used that is dragged over the floor, thereby dissipating electrostatic charges.

In either case, one must make sure that the electrostatic protection measures are functioning properly by checking, for example, that the resistance value has not risen to such a level that electrostatic charges cannot be dissipated because of dust or other electrically insulative particles adhering to the surface of the conductive wheel; furthermore, even if the electrostatic protection measures incorporated in the cart are functioning properly, it is desirable to constantly monitor the grounding condition of the cart because the earth ground cannot be established, for example, when the cart is moving over an insulative floor such as asphalt P tiles.

To check the grounding condition of the cart, one end of an ohm meter 18 is connected to the ground via a lead wire 20 and the other end is connected to the conductive mat 14 placed on the cart 10, as shown in FIG. 2, and the value indicated by the ohm meter 18 is read. With this method, however, the resistance value can be measured only within the range that the length of the lead wire 20 routed from the ohm meter 18 on the cart 10 to the grounding terminal can cover. Furthermore, since the lead wire 20 interferes with the movement of the cart 10, this method cannot be used to constantly monitor the resistance value, but can only be used to check the resistance value periodically.

### SUMMARY

Accordingly, it is an object of the present invention to provide a wheeled moving body incorporating electrostatic protection measures and capable of constantly monitoring its grounding condition, and a grounding condition monitoring apparatus for the same.

According to the present invention, there is provided a wheeled moving body comprising: an electrostatic conductive mat placed on the moving body; first grounding means, whose entirety is attached to the moving body so as to move with the moving body, electrically connected to the electrostatic conductive mat, and adapted to be grounded at a first contact point on a surface over which the wheeled moving body moves; second grounding means, whose entirety is attached to the moving body so as to move with the moving body, electrically insulated from the electrostatic conductive mat, and adapted to be grounded at a second contact point on the surface over which the wheeled moving body moves, the second contact point being spaced apart from the first contact point; and grounding condition detecting means, connected between the electrostatic conductive mat and the second grounding means, for continuously detecting a grounding condition of the electrostatic conductive mat.

According to the present invention, there is also provided a grounding condition monitoring apparatus for a wheeled moving body, comprising: an electrostatic conductive mat placed on the moving body; first grounding means, whose entirety is attached to the moving body so as to be able to move with the moving body, electrically connected to the electrostatic conductive mat, and adapted to be grounded at a first contact point on a surface over which the wheeled moving body moves; second grounding means, whose entirety is attached to the moving body so as to be able to move with the moving body, electrically insulated from the electrostatic conductive mat, and adapted to be grounded at a second contact point on the surface over which the wheeled moving body moves, the second contact point being spaced apart from the first contact point; grounding condition detecting means, connected between the electrostatic conductive mat and the second grounding means, for continuously detecting a grounding condition of the electrostatic conductive mat; and alarm output means for outputting an alarm indicating abnormality in the grounding condition based on a detection result supplied from the grounding condition detecting means.

At least one of the first and second grounding means is, for example, at least one conductive wheel.

Alternatively, one of the first and second grounding means is a conductive grip with which to push and move the moving body.

The grounding condition detecting means includes, for example, an ohm meter or a volt meter for measuring an electrical resistance or a voltage between the conductive mat and the second grounding means.

By providing the second grounding means whose entirety is attached to the moving body and is grounded at the second contact point spaced apart from the second contact point at which the electrostatic conductive mat is grounded, and by connecting the grounding condition detecting means between the electrostatic conductive mat and the second grounding means, it becomes possible to constantly monitor the grounding condition without interfering with the movement of the cart.

### BRIEF DESCRIPTION OF THE DRAWINGS

FIG. 1 is a diagram showing one example of how a transport cart is grounded according to the prior art.

FIG. 2 is a diagram showing a method of detecting the grounding condition according to the prior art.

FIG. 3 is a conceptual diagram showing a transport cart incorporating electrostatic protection measures according to one embodiment of the present invention.

FIG. 4 is an equivalent circuit diagram of the system of FIG. 3.

FIG. 5 is a conceptual diagram showing another example of a transport cart incorporating electrostatic protection measures according to one embodiment of the present invention.

FIG. 6 is a diagram showing one example of how a grounding condition monitoring apparatus for a wheeled moving body, according to the present invention, is mounted on the transport cart.

FIG. 7 is a diagram showing the connections of the various elements shown in FIG. 6.

FIG. 8 is a diagram showing a method of grounding resistance measurement that complies with ANSI/ESD-S7.1.

FIG. 9 is a diagram showing a method of grounding resistance measurement according to the present invention.

### DETAILED DESCRIPTION

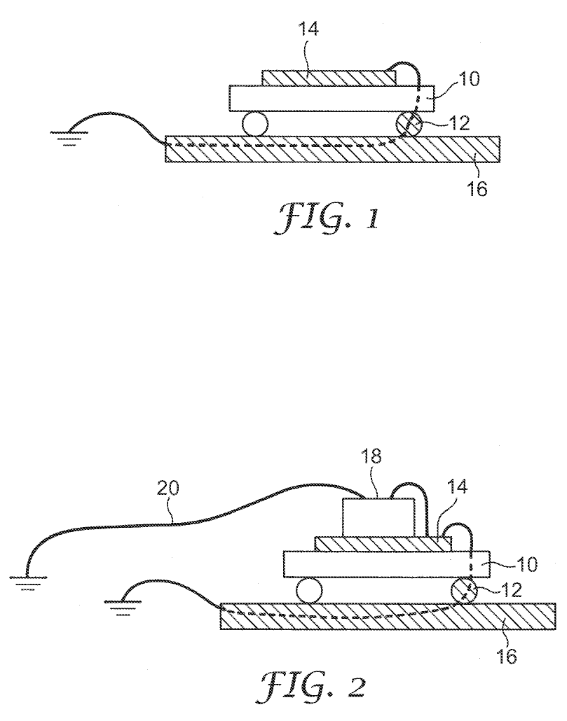

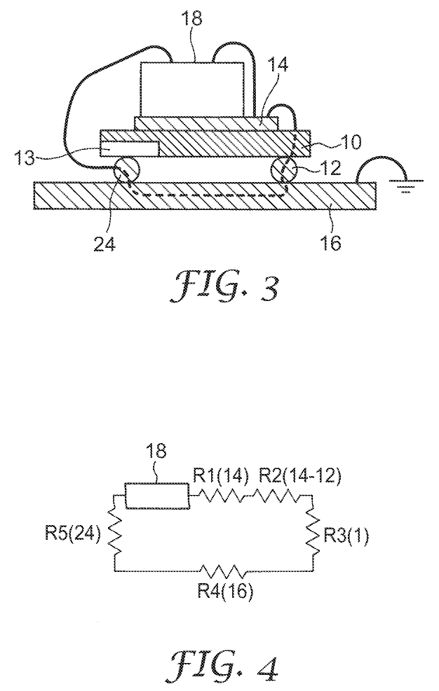

FIG. 3 is a conceptual diagram showing one example of a transport cart incorporating electrostatic protection measures according to one embodiment of the present invention. As in FIG. 1, the electrostatic conductive mat 14 placed on the cart 10 is electrically connected to the bearing of the conductive wheel 12 for grounding to the electrostatic conductive floor 16.

One end of the ohm meter (or volt meter) mounted on the cart 10 is connected to the electrostatic conductive mat 14, while the other end is connected to the bearing of another conductive wheel 24 insulated from the body of the cart 10 by an insulating plate 13. In this arrangement, that other end of the ohm meter (volt meter) is grounded at the point at which the wheel 24 contacts the floor 16, and which is spaced apart from the contact point of the wheel 12, and thus a closed circuit is formed as shown in the equivalent circuit of FIG. 4. In FIG. 4, R1 is the resistance of the electrostatic conductive mat 14, R2 is the resistance between the electrostatic conductive mat 14 and the wheel 12, R3 is the grounding resistance of the wheel 12, R4 is the resistance of the conductive floor 16 from the contact point of the wheel 12 to the contact point of the wheel 24, and R5 is the grounding resistance of the wheel 24. These elements form the closed circuit shown in FIG. 4; here, if reference numeral 18 is the ohm meter, the sum of the resistance values is measured by the ohm meter 18. If the resistance value indicated by the ohm meter 18 is larger than a predetermined value, then it can be determined that the grounding condition of the electrostatic conductive mat 14 is poor. Since the cart 10 can be moved around while maintaining the above arrangement, the grounding condition can be continuously monitored while the cart is moving. If reference numeral 18 is the volt meter, the voltage of the conductive mat with respect to ground, that is, the voltage occurring due to the electrostatic charge (the electrostatic charge generated, for example, by the friction caused between the floor and the wheels rolling over it) can be continuously monitored.

With the above cart, it is possible to constantly monitor the grounding resistance (leakage resistance) or voltage of the electrostatic conductive mat on the cart and thereby continuously monitor whether the electrostatic protection measures are functioning effectively. As a result, if the grounding condition degrades due to dust or other particles adhering to the wheels, the condition can be detected before it becomes a problem, and thus electrostatic-sensitive parts, circuit, etc. being transported on the cart can be prevented from being damaged by electrostatic discharge.

In the present invention, when the cart provided with the electrostatic protection measures is properly grounded, static electricity does not occur on the transport cart protected by the electrostatic protection measures or, if it does occur, the static electricity is quickly conducted to the antistatic floor through the casters. That is, electrostatic charges occurring on containers containing electrostatic-sensitive electronic parts, semifinished products, etc. placed on the transport cart are conducted to the floor via the mat on the cart and via the conductive casters or track-like rolling means.

An electrostatic conductive mat 9609 manufactured by Sumitomo 3M is used as the electrostatic conductive mat 14. DG525 manufactured by Sanwa Electric Instrument, for example, is used as the ohm meter 18. For the casters having conductive wheels 12 and 24, use is made, for example, of conductive casters HJ-75U-MCDG manufactured by SISIKU. A glass epoxy plate, for example, can be used as the insulating plate 12.

The above cart was tested in a place where Sumitomo 3M's electrostatic conductive mat 9609 was installed as the antistatic floor 16, and it was confirmed that the resistance value can be monitored not only when the cart is stationary but also when it is being moved around.

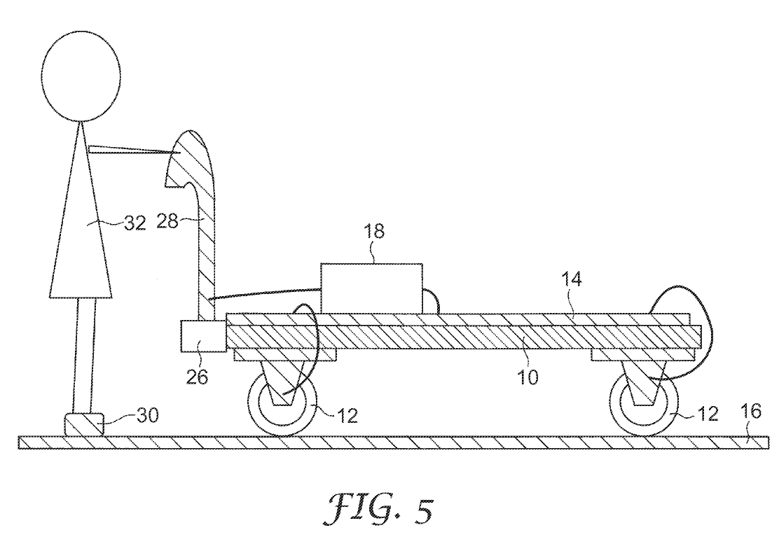

FIG. 5 shows another example of a transport cart incorporating electrostatic protection measures according to the present invention. In this example, a conductive grip 28 insulated from the body of the cart 10 by an insulating plate 26 is provided, rather than using the conductive wheel 24 insulated from the body of the cart 10 in the example of FIG. 3. When the operator wearing electrostatic conductive shoes 30 holds the conductive grip 28 in order to push and move the cart 10, that other end of the ohm meter 18 is grounded via the conductive grip 28, the human body 32, and the electrostatic conductive shoes 30.

The method of grounding the one end and/or the other end of the ohm meter 18 is not limited to the method that uses the conductive wheel or the conductive grip as described above, but alternatively the grounding may be accomplished, for example, by using a metal chain or belt-like conductive sheet as previously described.

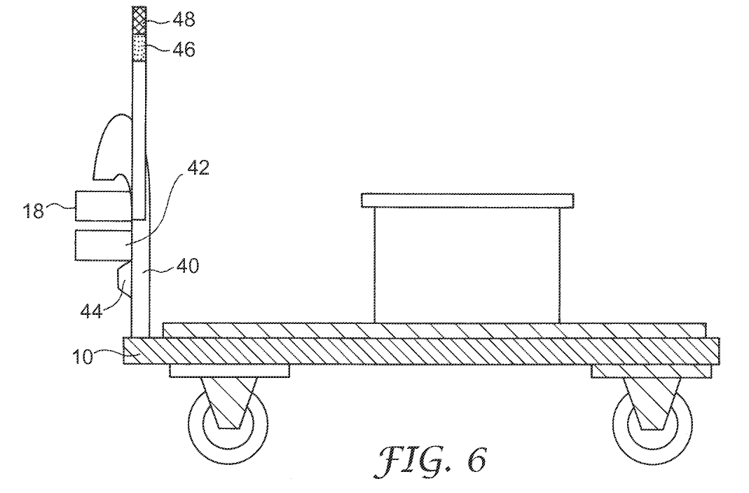

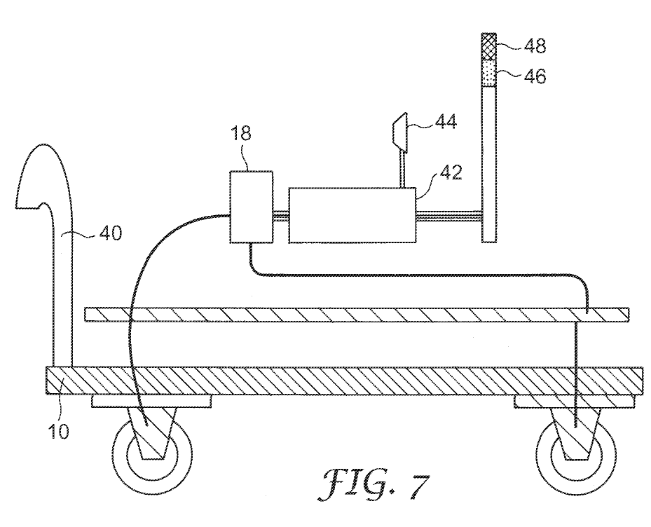

FIG. 6 shows one example of how a grounding condition monitoring apparatus for a wheeled moving body, according to the present invention, is mounted on the transport cart. FIG. 7 shows the connections of the various elements shown in FIG. 6.

In FIG. 6, the ohm meter 18, comparing/determining circuit 42, signal buzzer 44, normal indicator 46, and abnormality indicator 48 are mounted on a handle 40 of the cart 10. As shown in FIG. 7, the detection output of the ohm meter 18 is supplied to the comparing/determining circuit 42. In the comparing/determining circuit 42, the detection output of the ohm meter 18 is compared with a threshold value; if the detected resistance value is smaller than the threshold value, the normal indicator 46 lights, but if the detected resistance value is larger than the threshold value, the abnormality indicator 48 lights, and the signal buzzer 44 sounds. In an implementation example of the present invention, the apparatus may further includes a power supply unit, a recorder for recording sampled grounding condition information, a transmitter for transmitting the sampled information, etc.

There is a known correlation between the value of the grounding resistance obtained by a technique of grounding at two points using two different mutually insulated wheels, as in the present invention, and the value of the grounding resistance obtained by a standard technique of grounding resistance measurement, and the grounding condition can therefore be detected by the technique of the present invention as will be described below.

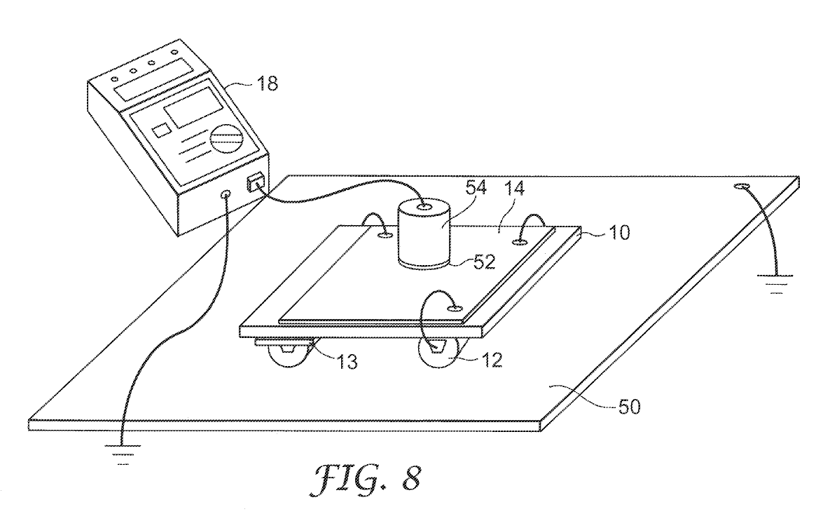

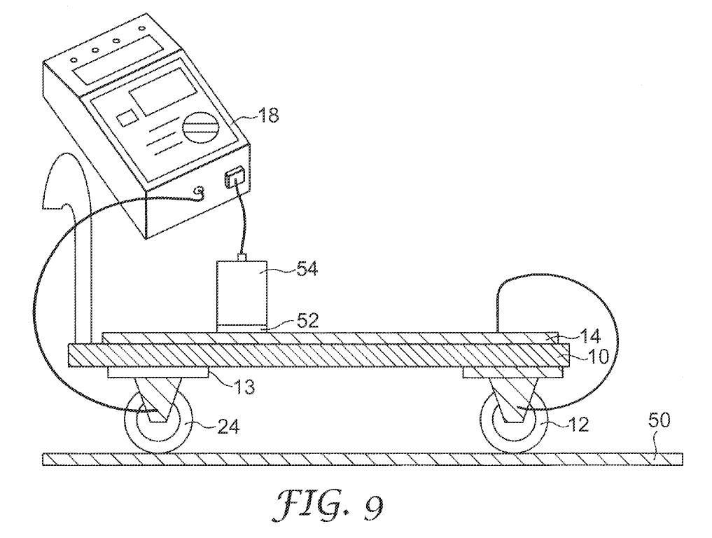

FIG. 8 is a diagram showing a technique of measuring the grounding resistance (leakage resistance) in accordance with ANSI/ESD-S7.1 when the conductive mat 14 on the cart 10 is grounded to a conductive mat 50 via three of the four conductive casters 12. The cart 10 is one manufactured by Ishikawa Seisakusho, and its four wheels are replaced by conductive casters manufactured by SISIKU (HJ-75×2 pieces and HK-75×2 pieces); three of them are connected to the conductive mat 14, and the remaining one is insulated from the body of the cart 10 by the insulating plate 13. A 50 cm by 80 cm electrostatic conductive mat 9609 manufactured by Sumitomo 3M is used as the conductive mat 14, and a 1.5 m by 1.5 m electrostatic conductive mat 9609 manufactured by Sumitomo 3M is used as the conductive mat 50.

In accordance with ANSI/ESD-S7.1, an electrode 54 measuring 63.5 mm in diameter and weighing 2.27 kg is placed on the conductive mat 14 by interposing a conductive rubber 52 between them, and the electrode 54 is connected to one end of the ohm meter 18 whose other end is grounded. A 3M 702 flooring tester is used as the ohm meter 18, and measurements are made by applying a voltage of 500 V.

FIG. 9 is a diagram showing the method of grounding resistance measurement according to the present invention. As shown, that other end of the ohm meter 18 is connected to the conductive caster 24 insulated from the body of the cart by the insulating plate 13. The other conditions are the same as those shown in FIG. 8.

Table 1 shows the results of the measurements made on the cart with no load and with a load applied by mounting a weight thereon, for the respective cases of FIGS. 8 and 9.

TABLE 1
Measurement Results

| | | UNIT: Mohm |
|---|---|---|
| | ANSI/ESD-S7.1 | Present Invention |
| Cart only | 430 | 2000 or higher |
| Cart + 65 kg | 340 | 1100 |
| Cart + 106 kg | 120 | 680 |

As can be seen from the results shown in Table 1, there is a known correlation between the result of the grounding resistance measurement obtained by the technique of the present invention and the result obtained by the standard technique, and this shows that the grounding condition can be detected by the technique of the present invention.

1. A wheeled moving body comprising:
an electrostatic conductive mat placed on said moving body;
first grounding means, whose entirety is attached to said moving body so as to move with said moving body, electrically connected to said electrostatic conductive mat, and adapted to be grounded at a first contact point on a surface over which said wheeled moving body moves;
second grounding means, whose entirety is attached to said moving body so as to move with said moving body, electrically insulated from said electrostatic conductive mat, and adapted to be grounded at a second contact point on said surface over which said wheeled moving body moves, said second contact point being spaced apart from said first contact point; and
grounding condition detecting means, connected between said electrostatic conductive mat and said second grounding means, for continuously detecting a grounding condition of said electrostatic conductive mat.

2. A wheeled moving body according to claim 1, wherein at least one of said first and second grounding means is at least one conductive wheel.

3. A wheeled moving body according to claim 1, wherein one of said first and second grounding means is a conductive grip with which to push and move said moving body.

4. A wheeled moving body according to claim 1, wherein said grounding condition detecting means includes an ohm meter for measuring an electrical resistance between said electrostatic conductive mat and said second grounding means.

5. A wheeled moving body according to claim 1, wherein said grounding condition detecting means includes a volt meter for measuring a voltage between said electrostatic conductive mat and said second grounding means.

6. A grounding condition monitoring apparatus for a wheeled moving body, comprising:
an electrostatic conductive mat placed on said moving body;
first grounding means, whose entirety is attached to said moving body so as to be able to move with said moving body, electrically connected to said electrostatic conductive mat, and adapted to be grounded at a first contact point on a surface over which said wheeled moving body moves;
second grounding means, whose entirety is attached to said moving body so as to be able to move with said moving body, electrically insulated from said electrostatic conductive mat, and adapted to be grounded at a second contact point on said surface over which said wheeled moving body moves, said second contact point being spaced apart from said first contact point;
grounding condition detecting means, connected between said electrostatic conductive mat and said second grounding means, for continuously detecting a grounding condition of said electrostatic conductive mat; and
alarm output means for outputting an alarm indicating abnormality in said grounding condition based on a detection result supplied from said grounding condition detecting means.
